(19) United States
(12) Patent Application Publication
(10) Pub. No.: US 2006/0238384 A1
(43) Pub. Date: Oct. 26, 2006

(54) System and method for portable communication device in an aircraft

(76) Inventors: Richard Hess, Bellevue, WA (US); Paul DeHerrera, Tucson, AZ (US); Brian Eckmann, Seattle, WA (US); Richard Gleason, Lacey, WA (US)

Correspondence Address: JABLONSKI AND REID, PLLC, 218 MAIN STREET, #140, KIRKLAND, WA, 98033, US

(21) Appl. No.: 11/321,572

(22) Filed: Dec. 28, 2005

Related U.S. Application Data
(60) Provisional application No. 60/642,190, filed on Jan. 5, 2005.

(51) Int. Cl. G08G 1/123; G08B 21/00; H04H 1/00

(52) U.S. Cl. 340/995.14; 340/995.26; 455/3.01; 340/945

(57) ABSTRACT

A system and method directed to providing a communication system for receiving data from sources outside the aircraft, storing the received information and then presenting the received information on a portable display device having a screen that may be read with the necessary information. The portable display device may interface with a docking station for receiving the data from a communication management unit and then removed and passed freely among flight attendants or other personnel on the aircraft. Further, the portable display device may be interfaced with other docking stations in other parts of the aircraft to communicate with the communication management unit.

### CROSS REFERENCE TO RELATED APPLICATION

This application claims priority from U.S. Provisional Application 60/642,190 titled, “SYSTEM AND METHOD FOR PORTABLE COMMUNICATION DEVICE IN AN AIRCRAFT,” which was filed on Jan. 5, 2005, and which is incorporated by reference.

### TECHNICAL FIELD OF THE INVENTION

The present invention relates, generally, to the field of telecommunications and more specifically, the present invention relates to a system and method directed to a communication system for handling communications within an aircraft or other vehicle.

### BACKGROUND OF THE INVENTION

Aircraft (and other large vehicles, such as ships) use a great number of communications systems to coordinate communications in air traffic between air traffic controllers, airports, and other aircraft (or vessel traffic in the case of ships). One such conventional system 100 is shown in FIG. 1 wherein a central-aircraft communication system 110 is typically located within an aircraft (not shown) and is operable to communicate with a number of exterior communications systems including an Aircraft Communication Addressing and Reporting System (ACARS) 120, Satellite Communications (SatCom) 121 and Telephony 122 systems. The central-aircraft communication system 110 typically further includes a communication management unit 111 for receiving various communications from the external communication systems mentioned above. Information received at the central-aircraft communication system 110 from any of these sources as well as others is typically assimilated and organized by the communication management unit 111.

A pilot or other aircraft personnel may interact with the communication management unit 111 via a message display and entry device 112 that is communicatively coupled to the communication management unit 111. In this manner, the individual may step through all received information for display or manipulation according to known methods and established standards for any number of types of information. Examples of received and assimilated information include air traffic updates, weather reports, gate assignments, pre-flight, flight, and post-flight checklists, etc. As is expected, sometimes this information may be useful to be printed on paper for easily marking up or handing to other aircraft personnel as the message display and entry device 112 is affixed to the cockpit and difficult to access by any other personnel other than the pilot.

Thus, the message display and entry device 112 is typically communicatively coupled to a printer 113 such that any information displayed on the message display and entry device 112 may be printed at the printer 113. As a result, the above-mentioned information may be printed such that a hard copy of the information may be passed to aircraft personnel not seated in the cockpit of the aircraft, e.g., flight attendants, etc. It is advantageous to be able to pass a physical copy of the information received to other people for use in a different part of the aircraft.

A problem with the system 100 of FIG. 1 is that printers 113 are inherently expensive. A typical printer 113 that conforms to established avionics standards may cost in the range of $15,000. Printers 113 also use ink and paper that must be maintained and replaced that adds an additional maintenance expense. Furthermore, printers 113 have many moving parts and may easily break or wear out after repeated use. A typical life cycle for a printer 113 used in this capacity is about one year. Printers 113 within the system 100 for aircraft communications are inefficient and are a frequent cause of failure and downtime.

### SUMMARY OF THE INVENTION

According to one embodiment, a system and method is directed to providing a communication system for receiving data from sources outside the aircraft, storing the received information and then presented on a portable digital communication device having a display that may be read with the necessary information. The device is portable and may interfaced with a docking station for receiving the data from a communication management unit and then removed and passed freely among flight attendants or other personnel on the aircraft. Further, the device may be plugged into other docking stations in other parts of the plane to interface with the communication management unit for an update of received information or to recharge the unit's batteries.

According to another embodiment, the device may be in communication with the central communication management unit continuously via a wireless communication connection. Furthermore, the device may include a display that is reversible such that the information may be displayed having a first side as a top side and then may be set for reverse display such that a second side, opposite the first side now becomes the top side with respect to the display. Such a reversible display, along with reciprocal control buttons on either side of the display allow user to switch between one-handed operation in the left hand and the right hand yet always have the display and respective control buttons comfortably accessible below the display.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 shows a conventional communications system that includes a portable display device within an aircraft and aircraft support systems;

FIG. 2 shows a communications system between an aircraft and aircraft support systems according to an embodiment of the invention;

FIG. 3 shows an isometric view of a docking station for interfacing with the portable display device shown in FIG. 2 according to an embodiment of the invention;

FIG. 4 shows an isometric view in more detail of the portable display device of FIG. 2 according to an embodiment of the invention; and

FIG. 5 shows a top view of an aircraft having several docking stations as shown in FIG. 3 for interfacing with the portable display device of FIG. 4 according to an embodiment of the invention.

### DETAILED DESCRIPTION

The following discussion is presented to enable a person skilled in the art to make and use the invention. The general principles described herein may be applied to embodiments and applications other than those detailed above without departing from the spirit and scope of the present invention. The present invention is not intended to be limited to the embodiments shown, but is to be accorded the widest scope consistent with the principles and features disclosed or suggested herein.

FIG. 2 shows a communications system 200 having a portable display device 250 enabled for use within an aircraft and aircraft support systems according to an embodiment of the invention. The communications system 200 may typically include an ACARS system 220, a SatCom system 221 and a Telephony system 222 all of which may be configured to communicate with a central-aircraft communication system 210 according to known standards and protocols. The central-aircraft communication system 210 typically includes a communications management unit 211 that may, in turn, be configured to communicate not only with various external communications systems (such as ACARS 220 and so on) but also with a message display and entry device 212. The communications management unit 211 may be configured for receiving various communications from the external communication systems mentioned above. Information received at the central-aircraft communication system 110 from any of these sources as well as others is typically assimilated and organized by the communication management unit 211.

A pilot or other aircraft personnel may interact with the communication management unit 211 via the message display and entry device 212 that is communicatively coupled to the communication management unit 211. In this manner, the individual may step through all received information for display or manipulation according to known methods and established standards for any number of types of information. Typically, the message display and entry device 212 is anchored to the cockpit of the aircraft and is situated to be most accessible by the pilot(s). As such, other personnel may experience a difficult time reading information displayed on the message display and entry device 212. As mentioned in the background, printers have provided a means for providing a portable copy of the needed information, but printers are expensive and unreliable.

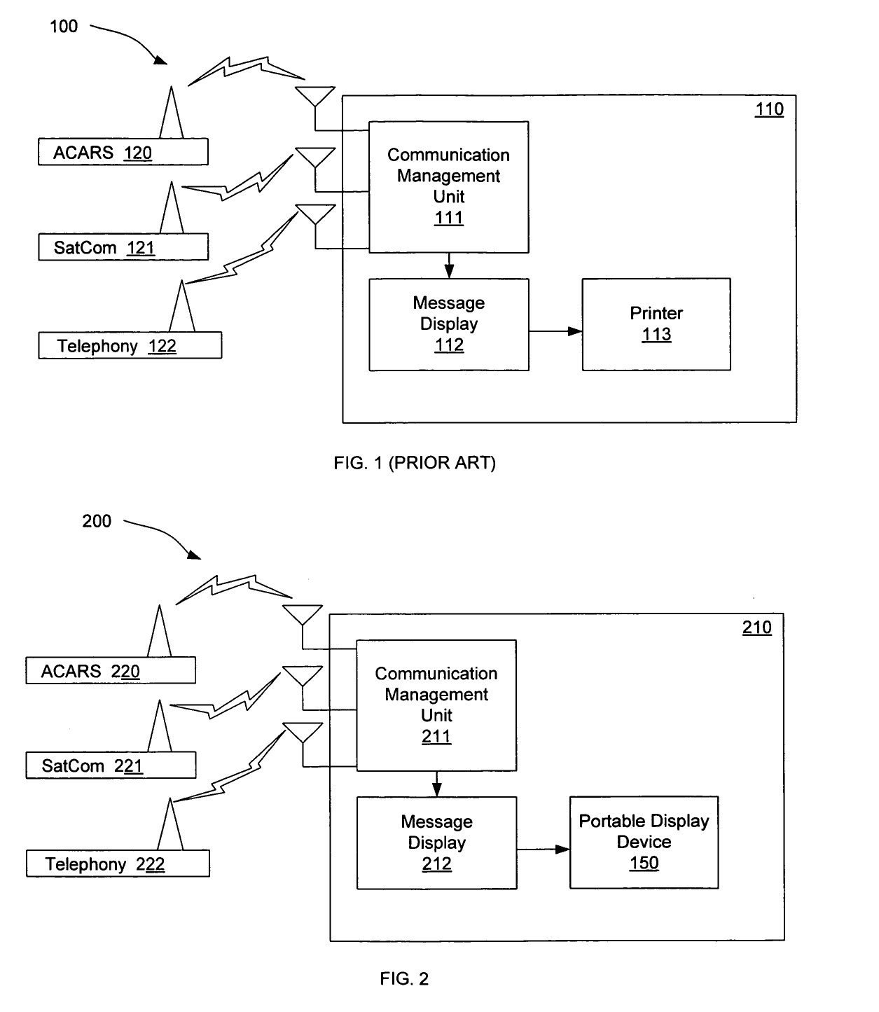

Thus, instead of having a printer, as was the case with a conventional system of FIG. 1, the central-aircraft communications system 210 of FIG. 2 includes a portable display device 250 for receiving and displaying data. The portable display device 250 takes the place of a conventional printer 113 (shown in FIG. 1) such that information may be called up and displayed on the portable display device 250 without having to print out a physical copy.

Having a portable display device 250 for retrieving and displaying any number of kinds of information typically communicated to an aircraft provides numerous advantages over conventional printers. The use of a portable display device 250 with an electronic display that replaces an electro-mechanical printer on an aircraft eliminates the required upkeep and maintenance associated with the conventional printer. Furthermore, with no moving parts and/or ink cartridges and paper to replace, annual costs associated with the portable display device 250 are negligible. The portable display device 250 and its associated docking station (not shown in FIG. 2) is also lighter and takes up less space than a conventional printer.

Additionally, the portable display device 250 is configured to have all information stored electronically may be passed between different aircraft personnel who may easily call up and display any desired information as to their needs. As such, a flight attendant may call up gate change information, a mechanic may call up maintenance records, a co-pilot may call up an emergency checklist, etc. The portable display device 250 may also be used to store and organize messages on an aircraft between personnel.

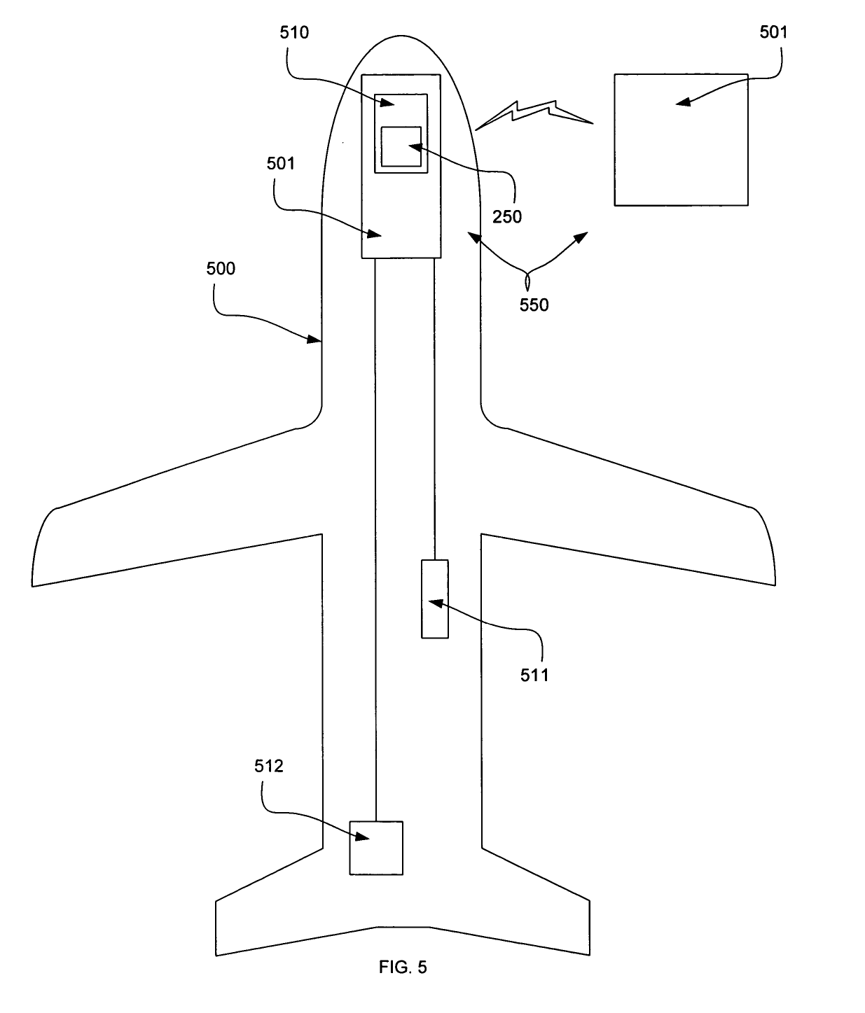

Further yet, the portable display device 250 with an electronic display may be used to record aircraft weight and balance data (i.e., occupied seats) and to transmit such information to a company dispatcher in an additional feature. Also, the portable display device 250 may provide a secure alternate communications links between the cockpit and the cabin crew using additional devices and docking stations (described below with respect to FIG. 5). Displayable information typically includes flight status, flight changes, flight crew information, weather information, aircraft performance, aircraft maintenance, current events, emergency information, checklist information, passenger information, and airport information. Still further, the portable display device 250 may typically include a unique latching mechanism to hold the portable display device 250 in place during maneuvering acceleration and turbulence on an aircraft and have features of a hand-held device that allows use with one hand (unique hand grip and button placement).

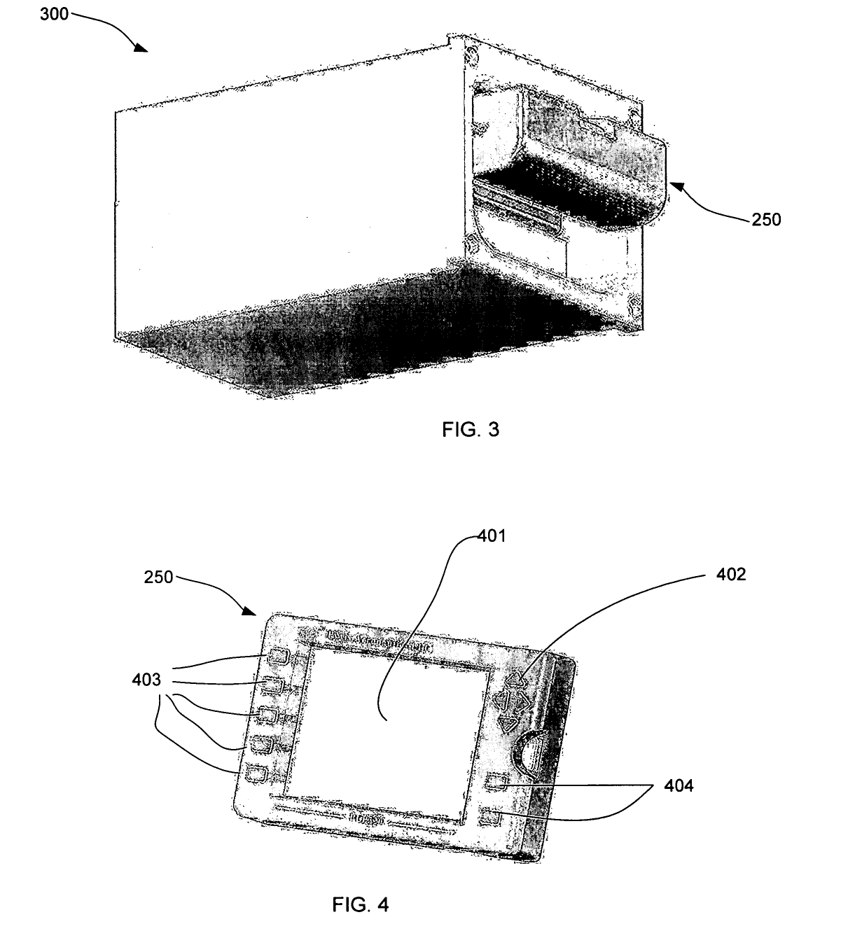

FIG. 3 shows an isometric view of a docking station 300 (sometimes called a receiver) for interfacing the portable display device 250 shown in FIG. 2 with the communications management unit 211 according to an embodiment of the invention. The portable display device 250 may typically interface with the docking station 300 using an Ethernet connection, an RS-232 communications link, a USB-type communications link, a fire wire communication link or any other communications links commonly found in communications systems. In other embodiments, the docking station 300 is merely a cradle for storing and charging the batteries (not shown) of the portable display device 250 as communications between the portable display device 250 and the communications management unit 211 may be a wireless communication connection.

The docking station 300 may be anchored in a position inside the cockpit of an aircraft but may be one of several docking stations 300 suitable for recharging and communicating with one or more portable display devices 250. As such, an aircraft may have several docking stations 300 located throughout the aircraft such that a portable display device 250 may be “plugged in” at any number of locations throughout an aircraft for recharging and receiving information stored by the communication management unit 211.

FIG. 4 shows an isometric view in more detail of the portable display device 250 according to an embodiment of the invention. The portable display device 250 typically includes a large, flat-panel display 401 that provides a screen for displaying information received from the communication management unit 211. The portable display device 250 also typically includes an interface (not shown in detail) for communicating with the central-aircraft communication system 210 that may be an RS-232 interface, a USB interface, a parallel port interface, a serial port interface, a fire wire interface, etc. In another embodiment, the portable display device 250 communicates with the central-aircraft communication system 210 via a wireless communication connection.

The screen of the portable display device 250 may also be manipulated to display the messages from any perspective of a potential user. The portable display device 250 typically includes a manipulative display such that the display may be manipulated with respect to the direction in which the user is viewing the display. For example, when docked, the display 401 may display the information from the perspective of a user sitting to the left (for a pilot) or to the right (for a co-pilot, or from the perspective of a user standing between the pilots. A user may easily change the orientations of the screen with the push of a pre-assigned soft-key (described below).

The portable display device 250 also typically includes a plurality of action and navigation buttons for manipulating the display to show various menus, options and information. As such, directional keys 402 are provided for maneuvering a cursor displayed on the display 401. Further, programmable function soft-keys 403 may be provided to actuate various options and manipulation parameters. Additionally, other buttons 404 are provided to realize additional functionality, such as power on/off, brightness, backlight, reverse display, update information, etc. It is appreciated that one skilled in the art realizes that any number of functions may be realized via known programming standards and tenets such that any of the following descriptive functionality may be initiated, controlled, manipulated, and otherwise realized via the programmable buttons described above. A detailed account of specific button functionality will not occur except to the extent the exemplary possible functions of the portable display device 250 that are described below

A typical portable display device 250 according to an embodiment of the invention may include the following features. Upon startup, the portable display device 250 may initiate a Power-Up Built In Test. Further, during operation a user may also begin a User-initiated Built In Test. Both tests are designed to run diagnostics to assure proper operation.

When in an initial state, the display may show a hierarchical menu structure of functions in which a user may navigate. The menu choices include at least the following:
1. Receive New Message
2. Read Messages
3. Delete Message
4. File Message
5. Recover Deleted Message
6. Change Flight Crew
7. Find Message
8. Create Folders
9. Delete Folders
10. Download Folders
11. Format Display
12. Get Help
13. Configure Display

These features are based a file management and page layout hierarchy that is well-known in the computer arts. A user may navigate through the menu and sub-menus using the directional keys and soft-keys described above.

File Management

Information received at a portable display device 250 is organized into files which are, in turn, organized into folders within the portable display device 250. There are at least two default folders that are typically always available and not able to be deleted or renamed: (1) Current Messages and (2) Deleted Messages. Other folders may be created, renamed, or deleted according to the needs of a user and/or the capacity in which the portable display device 250 is being used. The user may perform any action (such as opening folders and files) through the directional keys and soft-keys that affect the display. In another embodiment, a remote dispatcher may initiate control the portable display device 250 via ACARS commands in which the user may choose to accept or reject upon receipt of the ACARS message. As such, folders and files are used to organize information in an intuitive manner in the form of pages.

Page Layout

The home page is typically the default page that is displayed when first using the portable display device 250. The home page displays a list of top-level functions. In one embodiment, all functions are inoperative except messages. However, the default page when the portable display device 250 is removed from the docking station is typically a message list page for the Current Messages folder. The home page may further allow for a user to navigate to a plurality of additional pages.

A Message List page is the default when the display is removed from the docking station. The soft-keys 403 on the left allow the user to take action on the message highlighted by the cursor. The directional keys 401 allow the user to move the cursor between messages and to the sorting fields at the top of the list. Pressing an enter key displays a new page having the selected message or folder.

A Message page displays the contents of the folder shown in the top line. The default is to the Current Messages folder, which is where all newly received messages are stored. The new messages remain in this folder until deleted or moved to a different folder. A user may view multiple pages of the message using the up/down direction keys 401 or may view other messages in the folder using the left/right direction keys 401.

When the user selects a Store option while reading a message, a Store page is shown with available folders and other options. The user may navigate using directional/enter keys 401 to select a folder in which to store the message. When the desired folder has not been created yet, the user may select a Folders option to display a Folders page where new folders can be created or renamed or deleted. Once again, the user may navigate using the directional/enter keys 401 to view the Message List page for another folder. Adding new folders or renaming a folder takes the user to a page where alphanumeric characters can be selected from a list. Again, directional/enter keys 401 select characters from the list.

When the user wants to search for a message the Display page shows a page with a list of all stored messages than can be sorted in various ways. For instance, pressing the TIME key sorts the list by time received. Again using the directional/enter keys 401 displays the selected message.

As discussed above, various methods may be implemented by the portable display device 250. Each of these are described in further detail as follows.

Receive New Message

Purpose: To demonstrate the ability to receive a new message from the Base Station.

Precondition: Display contains 4-5 canned messages.

Triggers: User places the Display in the base station.

Basic Course:
1. Display lights the New Message indicator.
2. User removes Display from base station.
3. New Message indicator goes out.
4. Display shows the Message List page of the Current Message folder with a message retrieved from memory at the top of the list and the current time shown (the oldest unread message).

Alternates: (none)

Read Messages

Purpose: To demonstrate the ability to scroll through a message and between messages on the Message List page.

Precondition: Message List page contains several canned messages.

Triggers: User navigates to the Message List page.
User removes Display from Base Station.

Basic Course:
1. User presses Up or Down keys to scroll through a list of messages.
2. User presses Enter to show the Message page for the selected message.
3. User presses Up or Down keys to scroll through the message.
4. User presses Left or Right keys to scroll between messages.

Alternates: (none)

Delete Message

Purpose: To demonstrate the ability to delete a message. The demo unit retains it in Deleted Messages folder.

Precondition: Message page contains several canned messages. The Message page is displayed for any folder.

Triggers: User selects the Delete option.

Basic Course:
1. Display shows a dialog box asking the user to confirm the delete request.
2. User presses the Yes option.
3. Display moves the message to the Deleted Message folder.
4. Display shows the Message List page of the folder.

Alternate 1:
5. If the Display is showing a message in the Deleted folder and the User selects the Delete option, the Display shows a dialog box with “Permanently delete this message?”
6. User selects Yes.
7. Display deletes message from Deleted Message folder.
8. Display shows the Message List page for the Deleted folder with the cursor at the first message on the page.

Alternate 2:
9. In Step 6 User selects No.
10. Display shows Message page for Deleted folder with the same message in view.

File Message

Purpose: To demonstrate the ability to file a message to a folder. We assume there is a preamble to every message indicating the folder it should be stored in.

Precondition: Message or Message List page is displayed and contains at least one message.

Triggers: User selects the Store option.

Basic Course:
1. Display shows the Store Message page with an icon of the message to be filed, and the appropriate folder highlighted.
2. User presses Directional keys to select the destination folder.
3. User presses Enter.
4. Display stores message in highlighted folder.
5. Display shows message icon disappearing into selected folder (or, just blink the folder 3 times).
6. Display shows Message page for Current Message folder.

Alternate 1:
7. In Step 2 if User wants to create a new folder to store the message, User selects Folders option which activates the Create Folder use case.
8. When Create Folder is complete, User proceeds to Step 3.

Recover Deleted Message

Purpose: To demonstrate the ability to recover a deleted message.

Precondition: A message is in the Deleted folder. The Folders page is shown.

Triggers: User uses directional keys to highlight the Deleted folder.

Basic Course:
1. User presses Enter key.
2. Display shows the Message List page for the Deleted Folder with the most recent message highlighted.
3. User presses Store key.
4. Display shows the Store Message page with the appropriate folder highlighted.
5. User uses directional keys to highlight the destination folder.
6. User presses Enter.
7. Display moves the message to the indicated folder and displays the Message List page for the Deleted folder.

Alternates:
8. In Step 2 if there are no messages in the folder, the Display shows “(No Messages)”.

Change Flight Crew

Purpose: To demonstrate the ability for a new User to quickly delete all current messages plus all custom folders and contents, except those defined by the Dispatcher (uploaded by ACARS).

Precondition: There is a folder created on this display that was not uploaded via ACARS.

Triggers: User selects “Crew Change” option on Message or Message List page.

Basic Course:
1. Display shows Folders page, with first custom folder highlighted, and a dialog box “Delete xxx folder and contents?” (“xxx” is the folder name).
2. Pilot selects Yes.
3. Display deletes folder and all contents (all content move to Deleted Messages folder).
4. Display highlights next custom folder and repeats Steps 1 & 2 until none are left.
5. Display highlights Current Messages folder, with a dialog box “Delete all current messages?”
6. User selects Yes.
7. Display highlights Deleted Messages folder, with a dialog box “Permanently delete all messages?”
8. User selects Yes.
9. Display shows Message Page of Current Message folder with “(no messages)”.

Alternates:
10. If in Step 2 User selects No, Display does not delete item and proceeds to next folder.
11. If in Step 5 User selects No, Display does not delete current messages and shows the Message page of the Current Message folder.

Find Message

Purpose: To demonstrate the ability to locate a message anywhere in memory. This may be by navigating manually through folders, or by a list of all message in memory. Messages are sorted in folders by time of receipt, most recent first.

Precondition: Message page contains several canned messages. There are at least two other folders containing at least one message each.

Triggers: (none).

Basic Course:
1. User selects Message page.
2. Display shows Message page.
3. Use presses Left or Right directional keys to scroll between messages.
4. User selects Folders option.
5. Display shows Folders page with Current folder highlighted.
6. User uses directional keys to select a folder and presses Enter key.
7. Display shows Message page for that folder. The folder name is shown along the top of the page.

Alternate 1:
8. User selects Find Message option on Folders page.
9. Display shows Find Message page, which is a list of all message in memory, plus several line select key options to sort by name, folder or receive time/date.
10. Display highlights the first message on the list.
11. User presses Up or Down keys to highlight the desired message.
12. User presses Enter key.
13. Display shows Message page of folder in which the message resides.

Create Folder

Purpose: To demonstrate the ability to create custom folders for sorting messages.

Precondition: (none)

Triggers: User selects Add Folder option.

Basic Course:
1. Display shows Name Folder page with entry field for folder name and a list of characters allowed for naming.
2. User enters name for new folder by selecting characters from list using directional keys.
3. User selects Enter key.
4. Display shows a Folders page with all available folders.

Alternate 1:
5. If in Step 2 the User decides not to create a new folder, he selects the Cancel option
6. Display shows the Folders page with all pre-existing folders.

Delete Folder

Purpose: To demonstrate the ability to delete folders.

Precondition: (none)

Triggers: (none)

Basic Course:
1. User navigates to Folders page.
2. User uses directional keys to highlight a folder.
3. User selects Delete option.
4. Display shows a dialog box indicating number of messages in the folder, and asking the User to confirm the deletion of folder and all messages in the folder.
5. User selects Delete option.
6. Display deletes folder and all messages it contained from memory.
7. Display shows the Folders page with all available folders.

Alternate 1:
8. If in Step 4 there are no messages in the folder, the Display deletes the folder and shows the Folders page with all remaining folders.

Alternate 2:
9. If in Step 4 the User decides not to delete the folder, he selects the Cancel option.
10. Display shows a Folders page with all pre-existing folders.

Download Folders

Purpose: To demonstrate the ability to create custom folders via ACARS message. There are two options. In the first, the dispatcher creates one new folder “on the fly” by designating the new folder name in the preamble of the ACARS message. The Display creates the new folder as a result of the message being displayed. The second option is for the Dispatcher to create a complete new set of folders and erase the old ones.

Precondition: Display is docked.

Triggers: User presses TEST button three times within 2 seconds.

Basic Course:
1. New Message indicator lights.
2. User removes display from base station.
3. New Message indicator light goes out.
4. Display shows Message page with new message. Message indicates it contains a new folder set, and contains user instructions for (a) add new folder(s) only, or (b) add new folders and delete all current folders and contents.
5. User follows instructions in the message to add new folders only (for instance, hold down two buttons at one time).
6. Display creates new folders and displays Folders page.

Alternate 1:
7. If in Step 4 the User decides not to add the new folders, he does nothing.
8. Message remains on the Message page. User can return to this message any time and continue, or he can delete the message.

Alternate 2:
9. If in Step 4 the User decides to replace the existing folders with the new ones and delete all current messages, he follows the given instructions.
10. Display deletes all current folders and contents, adds the new folders, and shows the Folders page with the new folder set.

FIG. 5 shows a top view of an aircraft 500 having several docking stations of FIG. 3 for interfacing with one or more portable display devices 250 of FIG. 4 according to an embodiment of the invention. Although FIG. 5 depicts an aircraft 500, the communication system 550 of the present invention may be realized in any vehicle that may communicate via wireless transmissions with one or more communications systems based outside of the vehicle. For example, instead of an aircraft 500, the communications system 550 described in various embodiments above may be employed in a ship, water-born vessel, spacecraft, car, truck, military craft or virtually any vehicle wherein communications may be used.

As such, the communications system 550 (including both the on-board systems and the off-board systems) typically includes at least a first communication sub-system 501 located outside the aircraft 500, such that the first communication sub-system 501 operable to communicate with the aircraft 500. An example of the first sub-system 501 may be the ACARS system 220 depicted in FIG. 2. The overall system 550 further includes a second communication sub-system 502 located inside the aircraft 500 and operable to receive data from the first communication sub-system 501. An example of the second sub-system 502 may be the central-aircraft communication system 210 also depicted in FIG. 2. Finally, the system 550 includes a portable display device 250 operable to removably interface with the second communication sub-system 502 and to receive and display the data received by the second communication sub-system 502. As shown in FIG. 5, the interface may be one of a plurality of docking stations, such as a cockpit docking station 510, a galley docking station 511 or an aft docking station 512. Other locations and types of interfaces are contemplated, but not discussed herein for brevity.

Each of the docking stations 510, 511, and 512 may be typically communicatively coupled to the central-aircraft communication system 210 such that the portable display device 250 may operably interface with any docking station 510, 511, or 512 to receive information communicated from the off-aircraft communication sub-system 501. In an alternative embodiment, only the main docking station 510 in the cockpit may be communicatively coupled to the central-aircraft communication system 210 and each of the remaining docking stations 511 and 512 may be communicatively coupled just to the cockpit docking station and/or amongst each other. The communication coupling may typically be any standards often realized in an aircraft communications system, such as Ethernet or serial bus, but may also be any other commonly used medium and protocol, such as a wireless standard and protocol, for example.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

We claim:

1. A portable display device for use in an aviation communication system, the portable display device comprising:
a display operable to display information received from a host communication system in an aircraft; and
an interface coupled to the display and operable to communicate with the host communication system including receiving the information;
the portable display device removably engagable with the host communication system such that the portable display device may be portable while simultaneously displaying the received information.

2. The portable display device of claim 1 wherein the interface comprises a wireless communication interface.

3. The portable display device of claim 1 wherein the interface comprises a communication interface that is from the group including: an Ethernet interface, an RS-232 interface, a USB interface, a parallel port interface, a serial port interface, and a fire wire interface.

4. The portable display device of claim 1, further comprising at least one display navigation control operable to provide user control over the information on the display.

5. The portable display device of claim 4 wherein the at least one display navigation control comprises a display navigation control selected from the group including: a scroll command, a menu command, an on/off command, a file message command, a copy message command, a read message command, a delete message command, a create folder command, a move folder command, a recover deleted message command, a download message command, and a download folder command.

6. The portable display device of claim 1 wherein the display comprises a manipulative display such that the display may be manipulated with respect to the direction in which the user is viewing the display.

7. The portable display of claim 1 operable to display information from the group comprising: flight status, flight changes, flight crew information, weather information, aircraft performance, aircraft maintenance, current events, emergency information, checklist information, passenger information, and airport information.

8. The portable display device of claim 1 further operable to communicatively interface with a plurality of access points coupled to the host communication system located in remote stations in the aircraft.

9. A method for communicating between a central communication system and a portable display system in an aircraft, the method comprising:
receiving a communication signal from a communication hub outside the aircraft at the central communication system, the communication signal containing data;
determining a portion of the received data to be forwarded to a portable display device;
forwarding the portion of data to the portable display device; and
displaying the portion of data on the portable display device.

10. The method of claim 9, further comprising directly interfacing the portable display device with the central communication system to receive data, such that communication signals between the portable display device with the central communication system comprise signals formatted in an RS-232 format.

11. The method of claim 9, further comprising indirectly interfacing the portable display device with the central communication system to receive data, such that communication signals between the portable display device with the central communication system comprise signals formatted in a wireless format.

12. The method of claim 9, further comprising:
storing the received data in a memory in the portable display device; and
interfacing the portable display device with a remote docking station to update the data already stored in the portable display device.

13. The method of claim 9, further comprising:
manipulating data received at the portable display device; and
communicating manipulated data back to the central communication system.

14. The method of claim 9, further comprising recharging a battery within the portable display device when the the portable display is docked in a docking station.

15. The method of claim 9, further comprising
establishing a folder structure for messages received within the received information; and
storing the messages within the folder structure such that messages are recallable, removable, movable, and displayable.

16. A communications system comprising:
a first communication sub-system located outside a vehicle, the first communication sub-system operable to communicate with the vehicle;
a second communication sub-system located inside the aircraft and operable to receive data from the first communication sub-system; and
a portable display device operable to removably interface with the second communication sub-system and to receive and display the data received by the second communication sub-system.

17. The communication system of claim 16 wherein the first communication subsystem comprises at least one of an ACARS system, a SatCom system and a Telephony system and the second communication sub-system comprises a vehicle central communications management unit.

18. The communication system of claim 16, further comprising a plurality of docking stations communicatively coupled to the second communication sub-system such that the portable display device may operably interface with any docking station to receive information communicated from the first communication sub-system.

19. The communication system of claim 16, wherein the portable communication device comprises:
a display operable to display information received from the second communication sub-system; and
an interface coupled to the display and operable to communicate with the second communication sub-system including receiving the information;
the information display device removably engagable with the second communication sub-system such that the information display device may be portable while simultaneously displaying the received information.

20. The communication system of claim 16 wherein the communications system is further operable to communicate between the first communication sub-system, the second communication sub-system and the portable display device using a wireless communication protocol.
